(19) United States
(12) Patent Application Publication
(10) Pub. No.: US 2005/0168848 A1
(43) Pub. Date: Aug. 4, 2005

(54) Binder mirror

(76) Inventor: Jacqueline Marie Steady, Chap May, NJ (US)

Correspondence Address: Jacqueline M. Steady, 1021 Cape May Ave, Cape May, NJ, 08204, US

(21) Appl. No.: 10/770,813

(22) Filed: Feb. 3, 2004

(51) Int. Cl. G02B 5/08

(52) U.S. Cl. 359/838; 359/871

(57) ABSTRACT

A binder mirror having a base member secured to a mirror member. The mirror member rotates around a flat plane of the base member. Alternately, the mirror member rotates above a flat plane parallel to the base member. Yet another option includes a base member and a compact having a compact base member and a mirror member. The compact base member rotates above a plane parallel to said base member and the compact mirror member rotates around a plane parallel to said compact base member.

### BACKGROUND OF THE INVENTION

In the field of mirrors, the present invention is designed to provide a mirror that has an edge region with an aperture for receipt by a ring of a binder.

Mirrors have been formed in the shape of a compact This includes one member displaceable relative to a second member and including a mirror surface on at least one of the displaceable surfaces. The problem arises with mirrored compacts is that it is too cumbersome to hold a compact, a type of makeup, not including a mirror, and apply makeup with a brush or hold a compact and brush one's hair.

### SUMMARY OF THE INVENTION

Accordingly it is an advantage of the present invention that a mirror is provided that is securable in a binder.

Another advantage of the present invention is that a mirror is provided that is rotatable relative to a base member securable by a ring of a binder through at least one aperture where the mirror member does not overlap any of the aperture(s) of the base member and has complete desired rotation around the base member from a closed position to an open position and the rotation of the mirror member relative to the base member is free from interruption of the ring of the binder when secured to such a ring.

Yet another advantage of the present invention is that a binder mirror is provided that includes a mirror rotatable approximately 180 degrees relative to a base of binder mirror.

Another advantage of the present invention is that a binder mirror includes an opening device to ease opening of a mirror member relative to a base member of a binder mirror.

An alternate advantage of the invention is to include a base member with a mirror member rotatable above said base member, the rotation parallel to a plane above said base member.

Yet another alternate advantage of the invention is to include an opening enhancement.

Yet another alternate advantage is to include a swivel stop and or a rotation limiter.

An additional alternate advantage is to include a compact rotatable above a base member with a mirror member rotatable around a base of a compact member.

Yet another additional alternate advantage includes a swivel stop.

Yet another alternate additional alternate advantage includes swivel stops and or fastening devices with rotation limiters.

### BRIEF DESCRIPTION OF THE DRAWINGS

FIG. 1 is a front view of an open binder mirror according to the best mode of the invention;

FIG. 2 is a front view of a closed binder mirror according to the best mode of the invention;

FIG. 3 shows a three dimensional view of a base member;

FIG. 4a shows a three dimensional view of an integral mirror member and FIGS. 4b and 4c show a two piece arrangement of a mirror member;

FIG. 5a shows a top view of a base member and FIGS. 5b-5e show cross sectional views of the base member;

FIG. 6a shows a top view of another base member and FIGS. 6b and 6c show cross sectional views of this mirror member;

FIG. 7a shows a mirror base and FIGS. 7b and 7c show cross sectional views of a mirror base;

FIG. 8 shows a fastening device for the best mode of the invention;

FIGS. 9a-9b show post and rod arrangements;

FIG. 10 shows an alternate fastening device;

FIGS. 11a-11d show various opening features;

FIG. 12 shows a base member with an indentation;

FIG. 13 is a top view of a second embodiment of the invention;

FIG. 14 is a top view of a base member according to the second embodiment of the invention;

FIG. 15 is a top view of a mirror member according to the second embodiment of the invention;

FIGS. 16-17 show a binder mirror according to the second embodiment of the invention with opening features;

FIGS. 18-19 show a binder mirror according to the second embodiment of the invention with opening features and a swivel stop;

FIG. 20 shows a binder mirror according to a third embodiment of the invention in an open rotation, closed mirror position; and

FIG. 21 shows a binder mirror according to the third embodiment of the invention in an open rotation, open mirror position.

### DETAILED DESCRIPTION OF THE INVENTION

The present invention is directed to providing a mirror for a cosmetics case having a binder or simply a binder arrangement The entire contents of U.S. Pat. No. 6,164,451, issued Dec. 26, 2000 to Sherman, titled, “COSMETICS CASE,” is incorporated herein by reference.

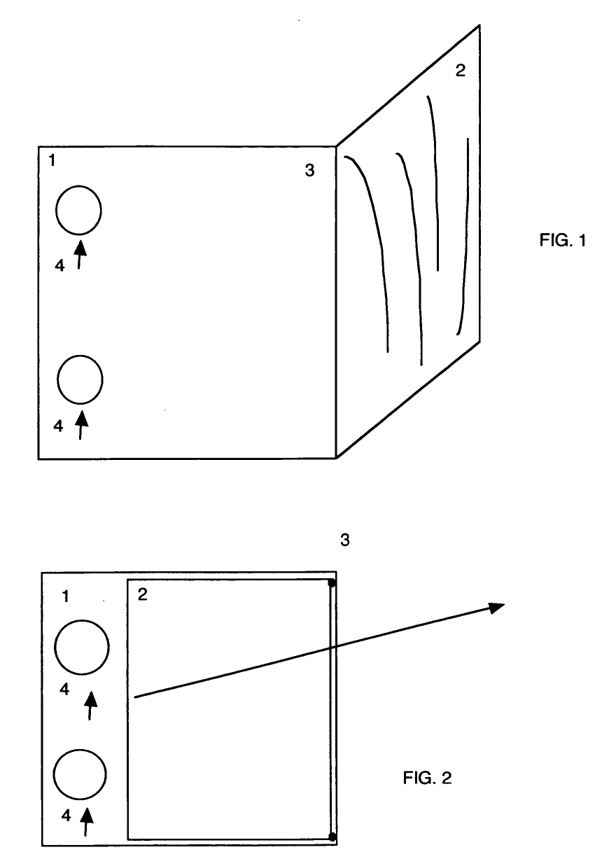

The best mode for carrying out the invention is shown in FIG. 1. FIG. 1 shows a binder mirror in an open position. The binder mirror includes a base member 1. Base member 1 is three dimensional, has four edges and is shaped in the form of a rectangle. Base member 1 includes at least one aperture 4 for receiving a ring of a binder (not shown). A plurality of apertures 4 are shown in FIG. 1. Typically a binder mirror according to this embodiment includes 2 or 3 apertures, although the number of apertures is not limited to those amounts. Apertures 4 are located along a first edge of edges of the base member. Mirror member 2 is three dimensional and includes a reflective surface or a mirror surface on one side of the mirror member. Base member 1 and mirror member 2 are joined by fastening device 3, discussed below. FIG. 2 shows a binder mirror according to FIG. 1 in a closed position.

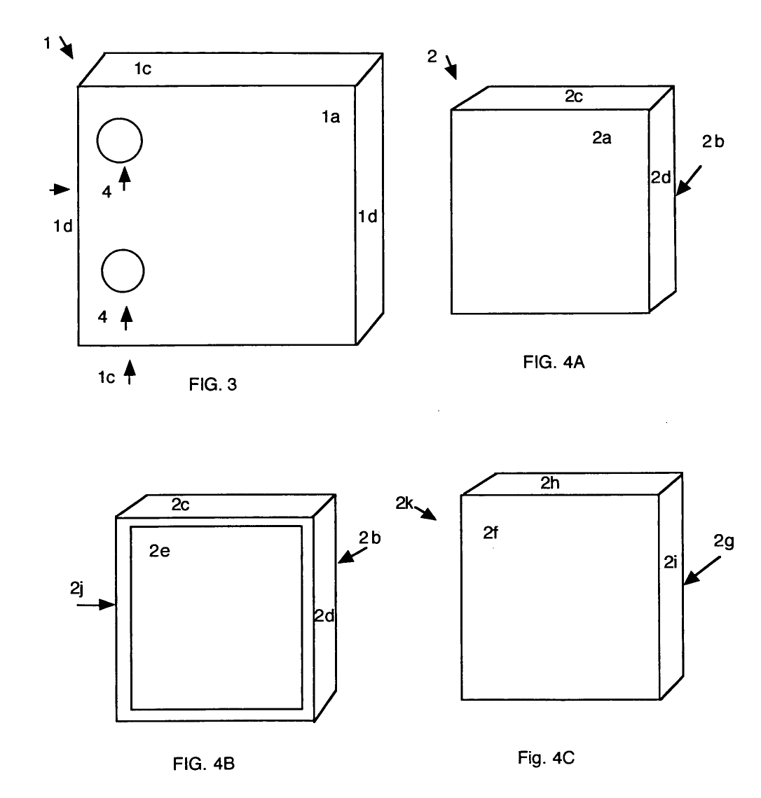

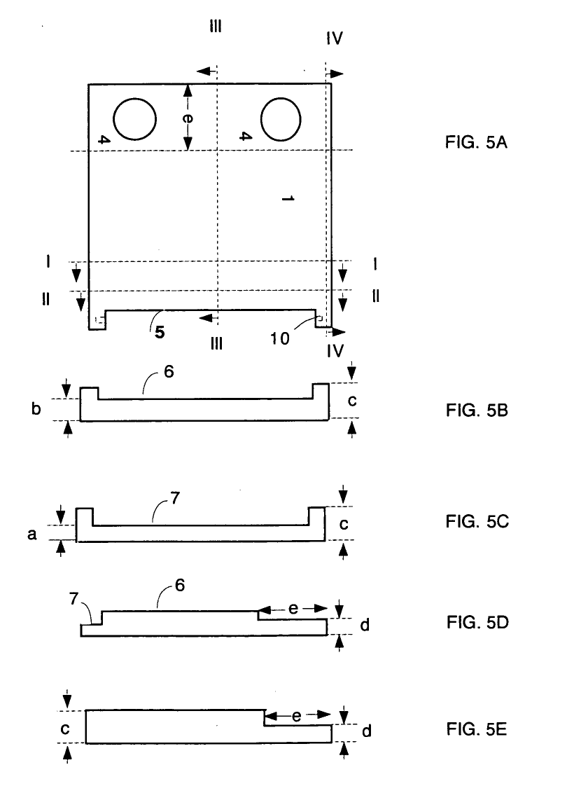

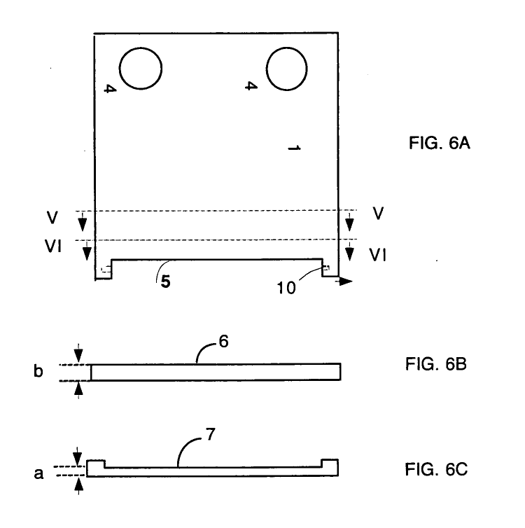

FIG. 3 shows base member 1 having top surface 1a, back surface 1b side surfaces 1c and 1d and apertures 4. FIG. 4a shows mirror member 2 having a top surface 2a, back surface 2b, and side surfaces 2c and 2d. Typically mirror member 2 is two separate pieces attached by a binding agent, such as adhesive, a binder, glue or molding, for examples. FIG. 4b shows the base of the mirror member 2j having a recessed portion for receiving a mirror. Top surface 2e of the mirror base 2j is attached to a mirror. FIG. 4c shows a typical three dimensional mirror 2k having top reflective surface 2f back surface 2g, and side surfaces 2h and 2i. FIGS. 5a-5e and 6a-6c show base member 1 and mirror base 2j altered from the shapes shown in FIGS. 3 and 4a-4c to include design features to arrive at the fastening device of FIG. 1. Typically base member 1 and mirror member 2 are a rigid material such as metal, plastic, acrylic or reinforced rubber, and may include outward ornamentation such as polished stones.

FIG. 5a shows a top view of base member 1 including notch 5 and recesses 10. Recesses 10 receive a fastening device, discussed in more detail below. FIG. 5b shows a cross sectional view along line I-I in FIG. 5a and FIG. 5c shows a cross sectional view along line II-II in FIG. 5a. Cross sectional views shown in FIGS. 5b and 5c show a stepped region of base member 1 where the steps have heights equal to “a” or “b.” Base member 1 includes notch 5 and the stepped region shown by the cross section so that mirror member 2 can be received and mirror member 2 is rotatable between a closed position and an open position. Typically, the height of “a” is less than the height of “b” so that base member 1 allows a protruding rounded side region to rest or be located about the stepped region and a top surface of a mirror member or a mirror base to rest on or be located around the base member. A stepped region can limit a degree of rotation of mirror member 2 around a plane parallel to base member 1. For example, a stepped region may limit relative rotation to approximately 90 degrees, 180 degrees or 270 degrees. An angled region next to notch 5 also would limit a degree of rotation of mirror member 2 relative to base member 1, for examples, rotation may be limited to approximately 90 degrees, 180 degrees or 270 degrees.

FIGS. 5d and 5e show cross sectional views along lines III-III and IV-IV in FIG. 5a. FIG. 5a shows the width of aperture area of the base member equal to “e.” The aperture area includes at least the region of the base member that surrounds apertures 4. The minimal requirements of the aperture area is the area from each aperture to the closest two or three side surfaces of the base member, for example. An aperture area may also extend in a direction opposite a direction to a nearest side, as shown as “e” in FIG. 5a. FIG. 5d shows the height of the aperture region is equal to “d.” Height “d” may vary according to the aesthetics of the situation. For instance, height “d” may be less than the height of an adjacent region as shown in FIG. 5a. Of course, there may be the occasion where height “d” is greater than height “b” or equal thereto, for examples. FIG. 5d shows a cross sectional view of the base member including a stepped region for receiving mirror member 2. FIG. 5e shows a cross sectional view of an edge region of base member 1 that does not include the stepped region. This edge region has a height equal to “c” so that the edge region comfortably includes a recess and is aesthetically pleasing. The above base member mates with mirror member 2.

A raised edge region “c” allows mirror member 2 to mate with base member 1. The edge region may be designed so that the aperture region mates with the mirror member 2 around the side regions of mirror member 2 that are not included with the fastening device 3. A raised edge region “c” having a height greater than “b” and an aperture region having a height varying from “b” are not required. If heights “b,” “c,” and “d” equal one another a region of mirror member 2 may rest on base member 1, as discussed below.

FIGS. 6a-6c show base member 1 having a notch 5 and a single stepped region. This design allows mirror member 2 to rest on base member 1. Cross sectional view V-V of FIG. 6a shown in FIG. 6b shows the height of the base member that allows a mirror member to rest thereon. Cross sectional view Vi-VI shown in FIG. 6c shows the stepped region of a base member. The stepped region receives a side region of a base of a mirror member, discussed below.

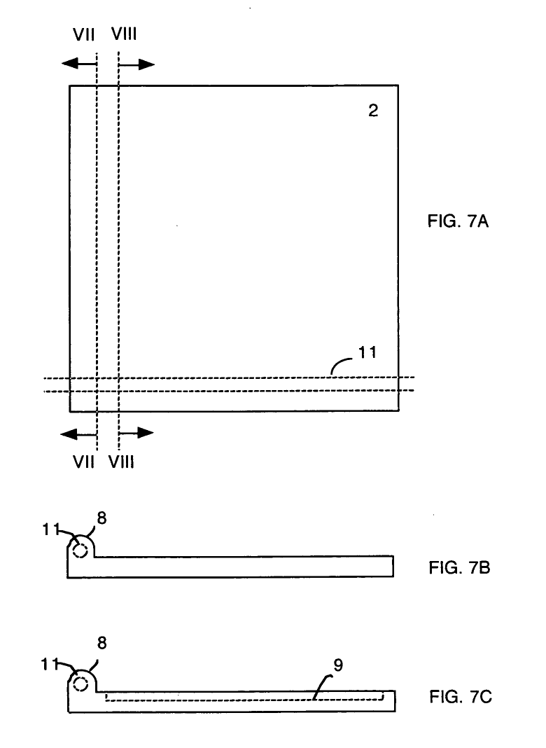

FIGS. 7a-7c show a mirror member for receipt by base member 1 as shown and described in FIGS. 5a-5e and 6a-6c. FIG. 7a shows mirror member 2, FIG. 7b shows a cross sectional view along line VII-VII of mirror member 2 and FIG. 7c shows a cross sectional view of mirror member 2 along line VIII-VIII. FIG. 7b shows mirror member 2 having a protruding, rounded side region 8 and aperture 11. Rounded side region 8 is prevented from rotation greater than a desired amount by the stepped region of the base member. Mirror member 2 typically rotates 170 degrees to 190 degrees relative to base member 1 to an open position from a closed position. Without a stepped region, member 2 is rotatable approximately 270 degrees relative to the base member. The cross sectional view along line VIII-VIII in FIG. 7b shows a region of the base of the mirror member at the edge region. In this region there is no mirrored surface. This is an edge region of base member 2j. Although mirror base 2j may be flat with a mirror glued thereon, it is preferred that the base of the mirror member includes a recessed region 9 so that edges of mirror are recessed or enclosed. This prevents an exposed sharp edge of a mirror when a mirror is glued to side 2e, for example. FIG. 6c shows cross sectional view where a dotted line shows recess 9 for receiving mirror 2j.

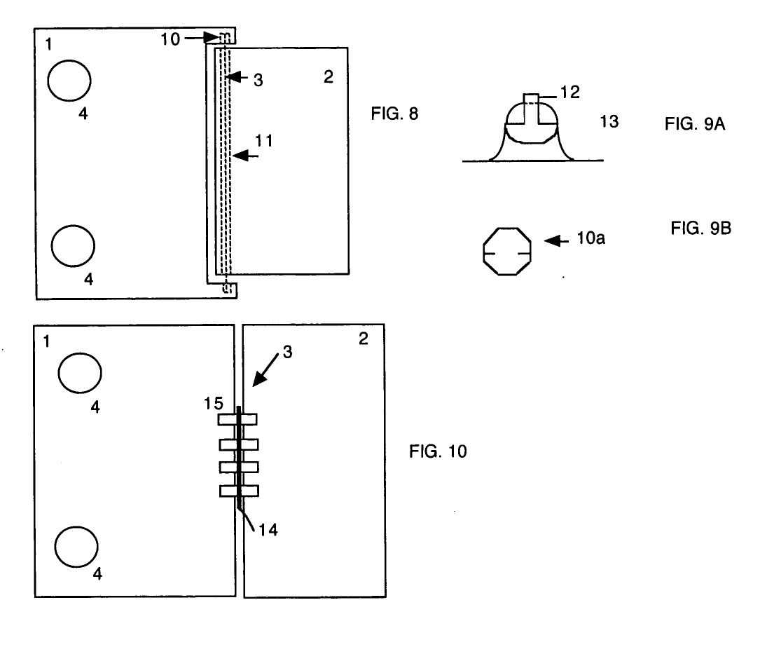

FIGS. 8 shows a fastening devices for rotatably joining base member 1 to mirror member 2. In FIG. 8, rod 12 is inserted through aperture 11 in mirror member 2. Rod 12 secures mirror member 2 to base member 1 by fitting in recesses 10. Rod 12 may be secured in recesses 10 by posts 13 shown in FIG. 9a. Posts may be integral with or secured in recesses 10. FIG. 9b shows a post member 10a integral with recess 10.

FIG. 10 shows a hinge 14 and bracket 15 arrangement for securing base member 1 to mirror member 2.

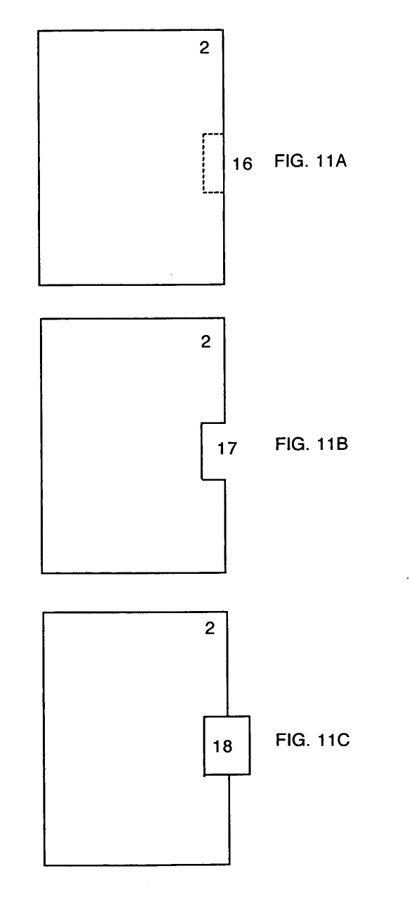

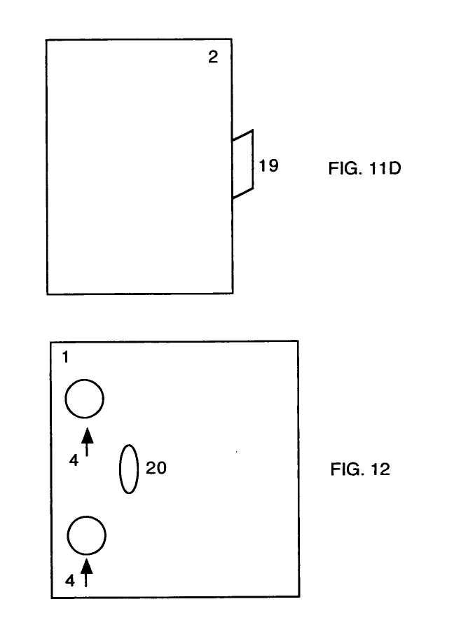

FIGS. 11a-11d show mirror member 2 including an opening device or feature. FIG. 11a shows mirror member 2 with an angled recess 16 to aide opening the binder mirror. FIG. 11b shows mirror member 2 with recess 17 to aide opening the binder mirror. It is not required that recess 17 extend to both exterior surfaces of mirror member 2. FIG. 11c shows mirror member 2 with extension 18 that may be integral, glued or hinged to base member 2. Extension 18 extends outwardly from the first edge or an alternate edge of mirror member 2. FIG. 11d shows mirror member 2 with extension 19 extending perpendicular to mirror member 2. FIG. 12 shows base member 1 with indentation or groove 20. Extension 19 is received by indentation 20, although extension 19 may be included without including indentation 20. Opening features may be made of the same material of the mirror base member.

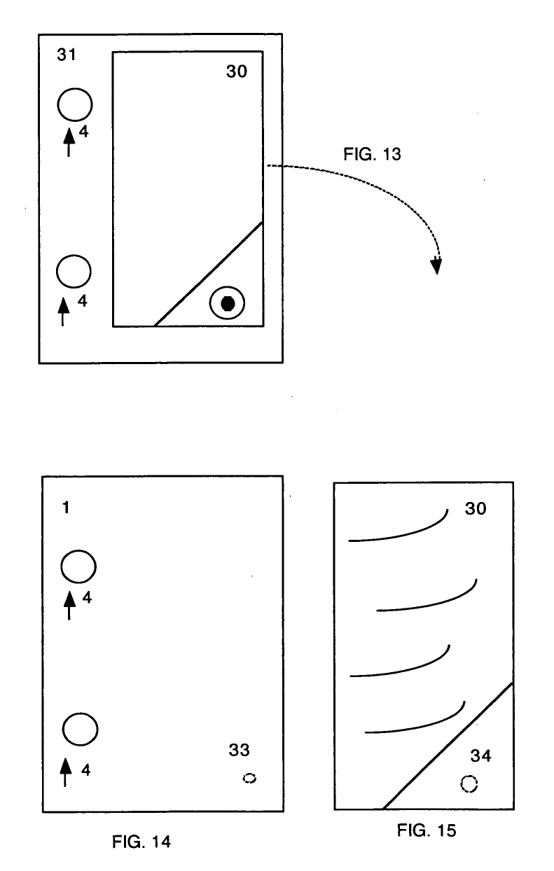

FIGS. 13-19 show a second embodiment of the invention. FIG. 13 shows base member 31, mirror member 30 and fastening device 32. Base member 31 includes apertures 4. In addition, in the second embodiment base member 31 includes an additional recess or aperture 33 as shown in FIG. 14. FIG. 15 shows mirror member 30 with recess or aperture 34. Fastening device 32 secures mirror member 30 to base member 31. In this second embodiment, mirror member 30 swivels or rotates with respect to base member 1. FIG. 13 shows an arrow indicating clockwise rotation. Rotation of 360 degrees, in either a clockwise or counterclockwise direction, is possible. Alternately, a fastening device may be designed so that rotation from a rest position is limited to a desired amount in either a clockwise or counterclockwise direction, the desired amount being 90 degrees, 180 degrees or 270 degrees, for examples.

Fastening device 32 may extend through said base member and said mirror member and be secured on exterior surfaces of said base member and said mirror member. Alternatively, fastening device 32 may be recessed in said base member and said mirror member. Fastening device 32 possibly allows rotation of said mirror member to said base member 360 degrees above a plane parallel to base member 31, as shown by the dotted arrow in FIG. 13. Of course, a fastening device may include a stop to prevent rotation past a certain degree in either a clockwise or a counterclockwise direction.

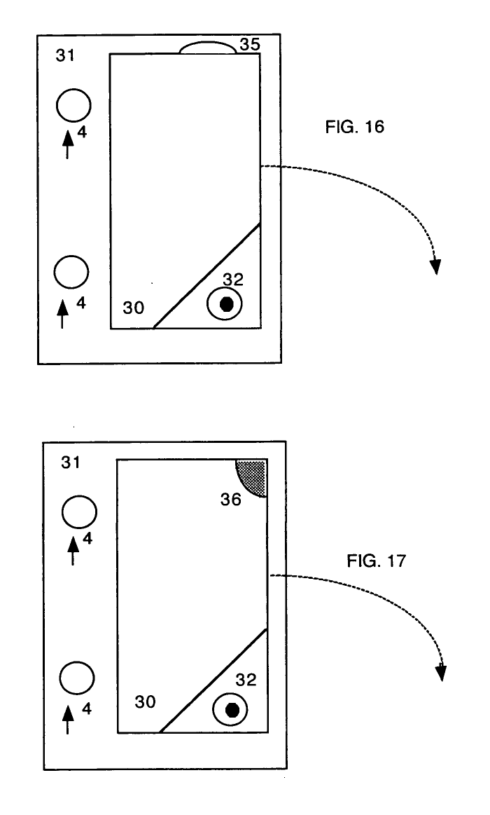

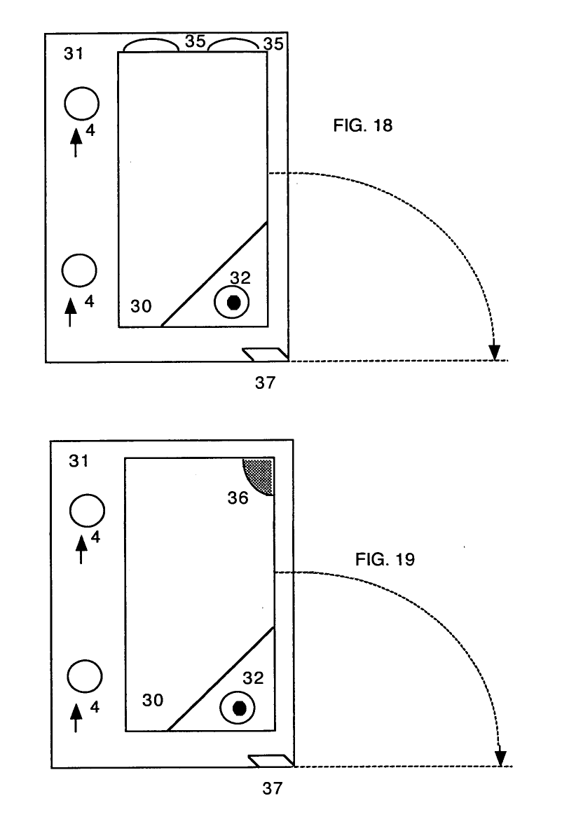

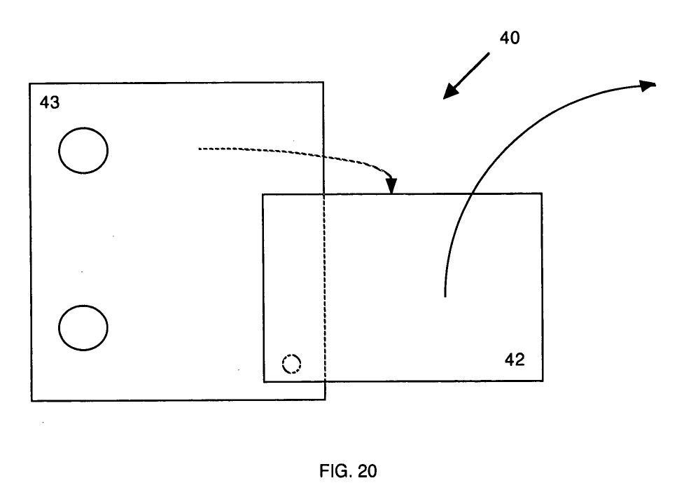

FIGS. 16 and 17 show the second embodiment of the invention with an opening device. The opening device enhances the ease of rotating the base member relative to the mirror member. Opening feature 35, shown in FIG. 16, is a pull handle to enhance the ease of swiveling or rotating mirror member 30 with respect to base member 31. FIG. 17 shows groove or indentation 36 in mirror member 30. Groove 30 is a gripping device to enhance the ease of swiveling or rotating mirror member 30 with respect to base member 31. FIGS. 18 and 19 show the second embodiment of the invention with protrusion or extension 37. Protrusion 37 prevents rotation or swiveling of mirror member 30 greater than 90 degrees, 135 degrees, 180 degrees, or 270 degrees with respect to the initial position of base member 1 and mirror member 30, for examples, depending on location relative to said mirror member.

As with the best mode of the invention, the three dimensional nature of both base member 31 and the mirror member 30 are designed to compliment one another. The mirror member typically includes a mirror base having a receiving region for a mirror. In addition, the mirror base includes additional area(s) to support a fastening device and an opening feature, if so desired. For example, an immediate area surrounding fastening device 32 does not receive a mirror. In the second embodiment, base member 31 may also be considered to have an aperture region as in the best mode of the invention. Base member 31 and base member 30 may be made from a rigid material as with the best mode of the invention, and of course, include a reflective surface or minor, with mirror member 30.

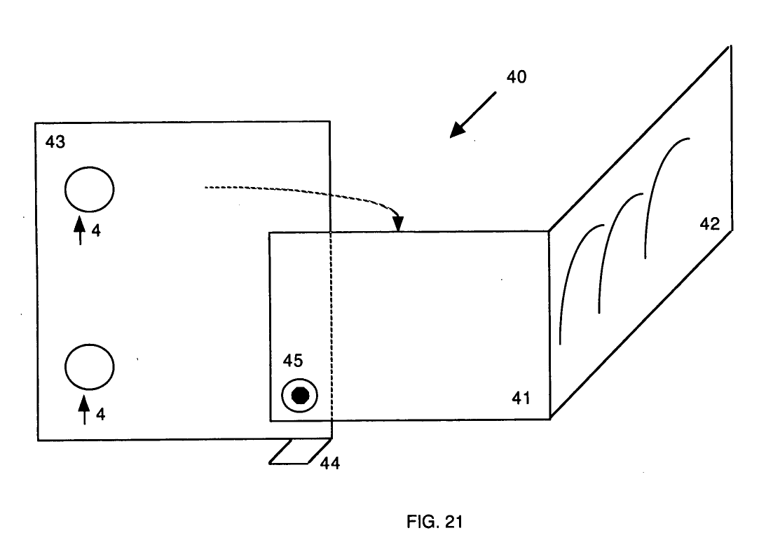

FIGS. 20 and 21 show a third embodiment of the invention. FIG. 14 shows a binder mirror according to the third embodiment of the invention having base member 43 and compact 40 with mirror member 42 rotated in a closed position. FIG. 21 shows base member 41, base of compact 40 rotated with respect to base member 43 and mirror member 42 open with respect to base member 41. FIG. 21 also shows optional swivel stop extension 44. Extension 44, prevents rotation or swiveling of compact base member 41 greater than a desired amount of 90 degrees, 135 degrees, 180 degrees or 270 degrees, for examples. Fastening devices 44 and 45 are similar to respective fastening devices in the best mode of the invention and the second embodiment of the invention.

A binder mirror of the present invention may include alternate shapes, mating arrangements and fastening devices consistent with the scope and spirit of the present invention.

1. A binder mirror comprising:
a base member having:
a top surface;
a bottom surface;
four side surfaces;
said top surface having at least four edges;
at least one aperture extending through the base member from the top surface to the bottom surface; and
a mirror member having:
a mirror base having:
a top surface;
said top surface including a recess for receiving said mirror;
a bottom surface;
four side surfaces; and
a binding agent securing said mirror to said mirror member;
a fastening device rotatably securing said base member to said mirror member along one of a side of said base member and a bottom surface of said base member;
said mirror member being rotatable around a plane parallel to said top surface of said base member, and
said mirror member rotatable from a closed position to an open position and not overlapping said at least one aperture of said base member.

2. A binder mirror according to claim 1, further comprising:
said base member defining an aperture region and a region adjacent said aperture region; and
said aperture region having a height different from a height of said region adjacent said aperture region.

3. A binder mirror according to claim 1, further comprising said fastening device being internal to said base member and said mirror member.

4. A binder mirror according to claim 3, further comprising:
a first side of said four sides of said base member having a notch recess and said mirror member being rotatable approximately 180 degrees from an open position to a closed position.

5. A binder mirror according to claim 4, further comprising:
said base member having said first side having a notch having a first end and a second end,
said base member having two internal recesses at respective ends of said notch,
said mirror member having a fastening aperture extending from a first side to a second side of said four sides;
said fastening device including a rod inserted through said fastening aperture of said mirror member and secured in said two recesses of said base member thereby securing said mirror member to said base member.

6. A binder mirror according to claim 5, further comprising a side of said four sides of said mirror member including said fastening aperture in said mirror member being at least partially rounded.

7. A binder mirror according to claim 5, further comprising said base member mating with said mirror member in a closed mirror member position.

8. A binder mirror according to claim 5, further comprising:
at least one post;
said at least one post being fitted in said at least one recess.

9. A binder mirror according to claim 1, further comprising said fastening device contacting the bottom surface of the base member and one of the top surface and the bottom surface of the mirror member.

10. A binder mirror according to claim 9 further comprising said fastening device including:
a hinge;
a bracket, and
said hinge and bracket securing said base member to said mirror member.

11. A binder mirror according to claim 10, further comprising said mirror member being rotatable approximately 180 degrees from a closed position to an open position.

12. A binder mirror according to claim 1, further comprising said at least one aperture including a plurality of apertures.

13. A binder mirror according to claim 1, further comprising:
said mirror member including an opening feature; and
said opening feature being one of a recess, an angled recess, a protrusion extending outwardly from said mirror member, and a protrusion extending perpendicularly from said mirror member.

14. A binder mirror according to claim 13, further comprising:
said opening feature being a protrusion extending perpendicularly from said mirror member, and
said top surface of said base member having at least one of a groove or indentation for receiving said protrusion extending perpendicularly from said mirror member.

15. A binder mirror according to claim 1, further comprising:
said base member and said mirror base member being reinforced rubber.

16. A binder mirror comprising:
a base member having:
a top surface;
a bottom surface;
four side surfaces;
said top surface having at least four edges; and
at least two apertures respectively extending through the base member from the top surface to the bottom surface;
a mirror member including:
a mirror;
a mirror base having:
a top surface;
said top surface including a recess receiving said mirror;
a bottom surface; and
four side surfaces; and
an adhesive securing said mirror to said mirror base;
a fastening device rotatably securing said base member to said mirror member,
said fastening device being internal to said base member and said mirror member,
said mirror member being rotatable around a plane parallel to said top surface of said base member, and
said mirror member rotatable from a closed position to an open position and said mirror member not overlapping said at least two apertures of said base member;
a first side of said four sides of said base member being stepped;
said first side of said base member having a notch having a first end and a second end;
said base member having two internal recesses at respective ends of said notch;
said mirror base having a fastening aperture extending from a first side to a second side of said four sides;
said mirror base having a protruding, rounded side including said fastening aperture of said mirror base;
said fastening device including a rod inserted through said fastening aperture of said mirror base and secured in said recesses of said base member thereby securing said mirror member to said base member;
said base member mating with said mirror member in a closed mirror member position; and
said mirror member rotatable approximately 180 degrees from a closed position to an open position.

17. A binder mirror according to claim 16, further comprising said base member and at least said mirror base being reinforced rubber.

18. A binder mirror according to claim 16, further comprising:
said fastening device including at least two posts; and
said two posts fitted in said two internal recesses, respectively, allowing said mirror member rotation around said base member.

19. A binder mirror according to claim 16, further comprising:
said mirror member including an opening device; and
said opening device being one of a recess, an angled recess, a protrusion extending outwardly from said mirror member and a protrusion extending perpendicularly from said mirror member.

20. A binder mirror according to claim 19, further comprising:
said opening device being a protrusion extending perpendicularly from said mirror member; and
said top surface of said base member having at least one of a groove or indentation for receiving said protrusion extending perpendicularly from said mirror member.

21. A binder mirror comprising:
a base member having:
a top surface;
a bottom surface;
a plurality of side surfaces;
at least one aperture extending through the base member from the top surface to the bottom surface; and
a mirror member having:
a mirror;
a mirror base having:
a top surface;
said top surface including a recess for said mirror;
a bottom surface;
a plurality of side surfaces; and
a fastening device rotatably securing said base member to said mirror member along one of:
one side of said plurality of sides of said mirror member,
said top surface of said mirror base, and
said bottom surface of mirror base member;
said mirror member being rotatable around a plane parallel to said top surface of said base member; and
said mirror member rotatable from a closed position to an open position and said mirror member not overlapping said at least one aperture of said base member in said closed position.

22. A binder mirror according to claim 21, further comprising said fastening device being at least partially internal to said base member and said mirror member.

23. A binder mirror according to claim 22, further comprising:
a first side of said plurality of sides of said base member having a stepped region; and
said mirror member rotatable approximately in a range of 160 degrees to 190 degrees from an open position to a closed position.

24. A binder mirror according to claim 23, further comprising:
said base member having said first side having a notch having a first end and a second end,
said base member having at least one internal recess at either end of said notch;
said base member secured to said mirror base at a side of said mirror base;
said side of said mirror base secured to said base member being protruded and rounded;
said mirror base having an aperture extending from a first edge to a second edge of said side of said mirror base secured to said base member;
said fastening device including a rod inserted through said aperture of said mirror base and secured in said at least one internal recess of said base member thereby rotatably securing said mirror member to said base member.

25. A binder mirror according to claim 24, further comprising:
said fastening device including two posts;
said at least one recess including two recesses; and
and said two posts fitted in said two recesses, respectively.

26. A binder mirror according to claim 25, further comprising:
said,two posts being integral with said base member.

27. A binder mirror according to claim 21, further comprising said fastening device contacting the bottom surface of the base member and one of the top surface and the bottom surface of the mirror member.

28. A binder mirror according to claim 27, further comprising said mirror member being rotatable approximately 180 degrees from a closed position to an open position.

29. A binder mirror according to claim 28, further comprising said fastening device including:
a hinge;
a bracket, and
said hinge and bracket securing said base member to said mirror member.

30. A binder mirror according to claim 21, further comprising said at least one aperture including a plurality of apertures.

31. A binder mirror according to claim 21, further comprising:
said mirror member including an opening device; and
said opening device being one of a recess, an angled recess, protrusion extending outwardly from said mirror member, and a protrusion extending perpendicularly from said mirror member.

32. A binder mirror according to claim 31, further comprising:
said opening device being a protrusion extending perpendicularly from said mirror member; and
said top surface of said base member having at least one of a groove and indentation for receiving said protrusion extending perpendicularly from said mirror member.

33. A binder mirror according to claim 21, further comprising said base member and at least said top surface of said mirror member being reinforced rubber.

34. A binder mirror according to claim 21, further comprising:
said base member including an aperture region having a first height;
an area adjacent said aperture region having a second height; and
said first height not equaling said second height.

35. A binder mirror comprising:
a base member having:
a top surface having a surface area;
a bottom surface;
four side surfaces; and
a plurality of apertures along a first side of said four sides;
said top surface surface area of said base member having a first surface area surrounding said plurality of apertures;
said top surface of said base member having a second surface area including a remainder of surface area outside said first surface area of said top surface area;
a mirror member having:
a mirror base having a receiving region; and
a mirror secured to said receiving region of said mirror base;
said mirror member having a surface area less than said second second surface area of said top surface of said base member;
a fastening device rotatably securing said base member to said mirror member at a corner region of said base member, said corner region adjacent a side opposite said first side of said base member; and
said mirror member rotatable in both a clockwise and counterclockwise direction above said base member.

36. A binder mirror according to claim 35 further comprising said fastening device preventing rotation greater than one of 270 degrees in a clockwise direction and 270 degrees in a counter clockwise direction.

37. A binder mirror according to claim 35 further comprising said fastening device preventing rotation greater than one of 180 degrees in a clockwise direction and 180 degrees in a counter clockwise direction.

38. A binder mirror according to claim 35 further comprising said fastening device preventing rotation greater than one of 90 degrees in a clockwise direction and 90 degrees in a counter clockwise direction.

39. A binder mirror according to claim 35, further comprising said fastening device recessed in and between said base member and said mirror member securing said base member to said mirror member.

40. A binder mirror according to claim 35, further comprising said fastening device extending through and secured on exterior sides of said mirror member and said base member.

41. A binder mirror according to claim 38, further comprising said plurality of apertures including two apertures.

42. A binder mirror according to claim 35, further comprising said at least one mirror member including at least on pull handle extending from an edge region of said mirror member.

43. A binder mirror according to claim 35, further comprising said at least one mirror member having at least one groove.

44. A binder mirror according to claim 35 further comprising a protrusion inhibiting rotation of said mirror member from a closed position.

45. A binder mirror comprising:
a base member having:
a top surface having a surface area;
a bottom surface;
a plurality of sides; and
a plurality of apertures along a first side of said plurality of sides;
said surface area of said top surface of said base member having a first surface area surrounding said plurality of apertures;
said surface area of said top surface of said base member having a second surface area including a remainder of surface area of said top surface outside of said first surface area;
a mirror member having:
a mirror base having a receiving region; and
a mirror secured to said receiving region of said mirror base;
said mirror member having a surface area less than said second second surface area of said top surface of said base member;
a fastening device rotabably securing said base member to said mirror member,
said mirror member rotatable at least one of clockwise and counterclockwise above a plane parallel to said base member; and
said fastening device partially positioned above said second surface area of said top surface of said base member.

46. A binder mirror according to claim 45 further comprising said fastening device preventing rotation greater than one of 270 degrees in a clockwise direction and 270 degrees in a counter clockwise direction.

47. A binder mirror according to claim 45 further comprising said fastening device preventing rotation greater than one of 180 degrees in a clockwise direction and 180 degrees in a counter clockwise direction.

48. A binder mirror according to claim 45 further comprising said fastening device preventing rotation greater than one of 90 degrees in a clockwise direction and 90 degrees in a counter clockwise direction.

49. A binder mirror according to claim 45, said fastening device recessed in and between said base member and said mirror member securing said base member to said mirror member.

50. A binder mirror according to claim 46, further comprising said fastening device extending through and secured on exterior sides of said mirror member and said base member.

51. A binder mirror according to claim 45, further comprising said at least one mirror member including at least on pull handle extending from an edge region of said mirror member.

52. A binder mirror according to claim 45, further comprising said at least one mirror member having at least one groove.

53. A binder mirror according to claim 45, further comprising a protrusion inhibiting rotation of said mirror member from a closed position.

54. A binder mirror comprising:
a first base member having:
a top surface with a surface area;
a bottom surface;
a plurality of sides;
a plurality of apertures along a first side of said plurality sides;
said surface area of said top surface of said base member having a first surface area surrounding said plurality of apertures;
said surface area of said top surface of said base member having a second surface area including a remainder of surface area of said surface area of said top surface outside of said first surface area
a compact member partially covering said base member and not overlapping said plurality of apertures;
said compact member having:
a compact base member;
said compact having a top surface area;
a mirror member,
said top surface area of said compact base member being less than said second surface area of said top surface of said base member; and
a first fastening device securing said compact base member to said mirror member; and
a second fastening device securing said first base member to said compact base member of said compact along a second side of said plurality of sides of said first base member.

55. A binder mirror according to claim 54, further comprising said first base member having at least four sides.

56. A binder mirror according to claim 54, further comprising:
said mirror member including an opening device; and
said opening device being one of at least one of an angled recess, and at least one recess extending inward, and a protrusion.

57. A binder mirror comprising:
a base member having having a top surface area;
said base member having an aperture region including at least one aperture;
said base member having a first surface area of said top surface surrounding said at least one aperture;
said base member member having a second surface area including a remainder of surface area of said top surface area outside of said first surface area;
a mirror member including:
a mirror base;
a mirror, and
said mirror being secured to said mirror base;
a fastening device displaceably securing said mirror member to said base member,
said fastening device at least partially positioned at one of a location above said base member and a location along a side of said base member;
said mirror member having a top surface area less than said second surface area of said top surface of said base member.
